(19) United States
(12) Patent Application Publication
(10) Pub. No.: US 2021/0116876 A1
(43) Pub. Date: Apr. 22, 2021

(54) POWER MANAGEMENT DEVICE

(71) Applicant: Mitsubishi Electric Corporation, Tokyo (JP)

(72) Inventors: Shinichiro OTANI, Tokyo (JP); Fuyuki SATO, Tokyo (JP); Yoshinori NAKAJIMA, Tokyo (JP); Hiroki KAWANO, Tokyo (JP); Toshihiro MEGA, Tokyo (JP)

(73) Assignee: Mitsubishi Electric Corporation, Tokyo (JP)

(21) Appl. No.: 17/137,087

(22) Filed: Dec. 29, 2020

Related U.S. Application Data
(63) Continuation of application No. PCT/JP2019/027658, filed on Jul. 12, 2019.

(30) Foreign Application Priority Data
Aug. 23, 2018 (JP) 2018-155892

(51) Int. Cl. G05B 19/042; H02J 13/00

(52) U.S. Cl. CPC G05B 19/042; G05B 2219/2639; H02J 13/00002

(57) ABSTRACT

An apparatus control unit (54) executes baseline judgment control of canceling power consumption limitation for a management target apparatus (20) throughout a predetermined judgement period within a demand term. A demand control execution judgment unit (48) judges whether or not a value of a baseline BL, which is an estimated value based on an integrated value of power consumption per building in the judgment period, exceeds a demand control execution value P_Dmd by a demand-term end point. When it is judged that the value of the baseline BL exceeds the demand control execution value P_Dmd by the demand-term end point, the apparatus control unit (54) executes demand control of limiting power consumption of the management target apparatus (20), after the judgment period. Furthermore, when the demand control is being executed at the demand-term end point, the apparatus control unit (54) executes limitation relaxing control of gradually relaxing limitation on the management target apparatus (20), before the judgment period in a next demand term.

### CROSS REFERENCE TO RELATED APPLICATIONS

This application is a Continuation of PCT International Application No. PCT/JP2019/027658, filed on Jul. 12, 2019, which claims priority under 35 U.S.C. 119(a) to Patent Application No. 2018-155892, filed in Japan on Aug. 23, 2018, all of which are hereby expressly incorporated by reference into the present application.

### TECHNICAL FIELD

The present invention relates to a power management device which performs power management by demand control.

### BACKGROUND ART

For example, a subscriber (for example, a building owner) of high-voltage power reception in an architectural structure such as a building concludes a power reception contract that defines contracted power, which is the maximum value of power consumption in the architectural structure, with an electric power supplier. The calculation unit of power consumption is expressed by average power consumption per unit time. For example, an average value (demand power) of power consumption of the entire building in a predetermined period (for example, 30 minutes) called demand term is to be compared with the contracted power.

For example, when demand power actually consumed in a building exceeds a predetermined contracted power, the basic charge for a contract period (for example, one year) is set based on the exceeding demand power regardless of the contracted power.

In view of this, an Energy Management System (EMS) that keeps power demand of a building to be equal to or below the contracted power has been conventionally known. The power management system performs power management based on so-called demand control.

For example, a demand control execution value is set at a value lower than the contracted power. Then, when it is predicted that the power demand will exceed the demand control execution value, the power consumption of a management target apparatus is reduced so as to avoid the excess. For example, some of apparatuses in operation are stopped.

Among services added to such demand control, a service is known which calculates a reduction amount of power consumption achieved by executing the demand control. For example, in Patent Literature 1, a predicted power usage amount is calculated based on a power consumption amount for a state where energy saving measures are not practiced, and a predicted energy usage amount with energy conservation being practiced is predicted. In Patent Literature 2, a baseline is obtained based on an actual value of a past power consumption amount, and an amount of power by which the power consumption amount under demand control is below the baseline is regarded as a power reduction amount.

### CITATION LIST

### Patent Literature

Patent Literature 1: JP 2011-242046 A

Patent Literature 2: JP 2014-96946 A

### SUMMARY OF INVENTION

### Technical Problem

In conventional demand control, in order to obtain a power reduction amount achieved by demand control, a baseline which is an estimated power consumption value under an assumption that demand control is not executed is calculated. For example, execution of demand control is stopped once, and power consumption during a period where execution of demand control is stopped is acquired at a plurality of points. Further, for example, an approximate straight line is obtained based on the power consumption at the plurality of points, and the obtained approximate straight line is regarded as the baseline.

However, when obtaining the baseline, if demand control that has been executed until then is interrupted, there is a possibility that apparatuses whose outputs have been suppressed until demand control is interrupted will increase their outputs simultaneously. For a user such as a tenant of a building where such apparatuses that may likely to increase their outputs simultaneously are installed, when the peripheral apparatuses simultaneously operate with a high output, their operating noise may be annoying and make him or her feel uncomfortable.

It is, therefore, an objective of the present invention to provide a power management device capable of relaxing more than before a sudden change in apparatus operation that occurs in switching ON/OFF of demand control.

### Solution to Problem

The present invention relates to a power management device. This device includes a control unit, a power detection unit, and a judgment unit. The control unit controls power consumption of a management target apparatus installed in a building. The power detection unit detects power consumption per building, which is power consumption of the entire building, at a predetermined timing within a demand term. The judgment unit judges whether or not an integrated value of the detected power consumption per building exceeds a predetermined demand control execution value by a demand-term end point. The control unit executes baseline judgment control of canceling power consumption limitation for the management target apparatus throughout a predetermined judgement period within the demand term. The judgment unit judges whether or not a value of a baseline, which is an estimated value based on the integrated value of power consumption per building in a judgment period, exceeds the demand control execution value by the demand-term end point. When it is judged that the value of the baseline exceeds the demand control execution value by the demand-term end point, the control unit executes demand control of limiting power consumption of the management target apparatus, after the judgment period. Furthermore, when demand control is being executed at the demand-term end point, the control unit executes limitation relaxing control of gradually relaxing limitation on power consumption for the management target apparatus, before a judgment period in a next demand term.

According to the above invention, limitation relaxing control is executed between the demand-term end point and the judgment period of the next demand term, in other words, during demand control ON/OFF operation. Therefore, a sudden change in apparatus operation can be relaxed.

In the above invention, the control unit may execute, after the judgment period, demand control of a predetermined control level based on a demand control list for each of a plurality of control levels at which limiting contents of the power consumption for the management target apparatuses are different. In this case, the control unit may execute the demand control in the limitation relaxing control, such that a shift from demand control of a level executed at the end point of the immediately preceding demand term to a level at which a limiting content of power consumption is relaxed is carried out stepwise.

According to the above invention, in limitation relaxing control, the control level is shifted stepwise toward relaxing the limitation. A control content of each control level is fixed. Limitation on the power consumption is relaxed by only shifting the control level. Therefore, in limitation relaxing control, a cumbersome operation such as selecting a relaxing target apparatus whenever needed is avoided, and smooth limitation relaxing can be performed.

Also, the above invention may include a power reduction amount calculation unit which calculates a power reduction amount from a difference between the value of the baseline at the demand-term end point and the integrated value of power consumption per building at the demand-term end point.

According to the above invention, a so-called energy conservation effect achieved by demand control can be calculated as a power reduction amount for each demand term.

### Advantageous Effects of Invention

According to the present invention, a sudden change in apparatus operation that occurs in switching ON/OFF of demand control can be relaxed more than before.

### BRIEF DESCRIPTION OF DRAWINGS

FIG. 1 is a diagram illustrating a power system diagram including a power management device according to the present embodiment.

FIG. 2 is a diagram illustrating function blocks of the power management device.

FIG. 3 is a diagram describing an integrated value of power consumption per building in demand control.

FIG. 4 is a diagram (1/2) describing an execution process of demand control.

FIG. 5 is a diagram (2/2) describing the execution process of demand control.

FIG. 6 is a diagram illustrating control level lists.

FIG. 7 is a diagram illustrating a demand control process according to the present embodiment.

FIG. 8 is a flow chart (1/2) illustrating a demand control flow according to the present embodiment.

FIG. 9 is a flow chart (2/2) illustrating the demand control flow according to the present embodiment.

FIG. 10 is a diagram supplementing a hardware configuration of the power management device according to the present embodiment.

### DESCRIPTION OF EMBODIMENTS

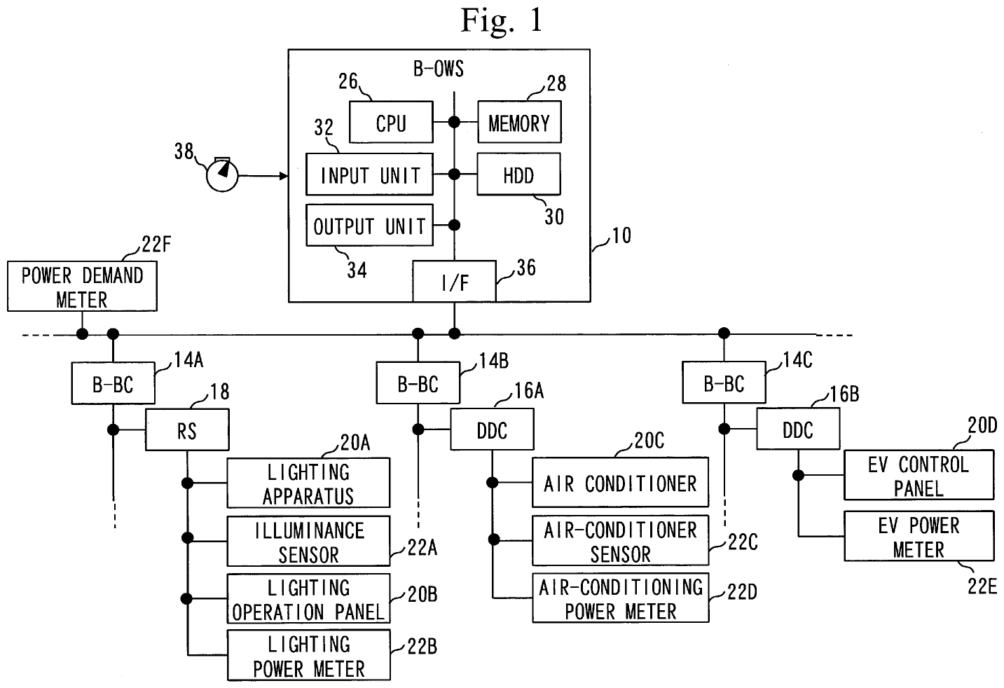

FIG. 1 illustrates a power management system including a power management device 10 according to the present embodiment. The power management system illustrated in FIG. 1 is composed of a Building and Energy Management System (BEMS) being a monitoring control system for facilities of a multistory construction such as a building.

The power management system is provided with the power management device 10 (B-OWS), sub-controllers 14A to 14C (B-BC), digital controllers 16A and 16B (D-DC), and a remote station 18 (RS), which are connected to a bus. The digital controllers 16A and 16B and the remote station 18 are connected to electrical apparatuses 20A to 20D, being management target apparatuses, and various types of sensors 22A to 22F.

The electrical apparatuses 20A to 20D are various types of facility apparatuses installed in a building, which are management target apparatuses of the power management device 10. The electrical apparatuses 20A to 20D include, for example, a lighting apparatus, an air-conditioning apparatus, an elevator, a sanitary apparatus, a disaster prevention apparatus, and a crime prevention apparatus. In the case of FIG. 1, the electrical apparatus 20A is a lighting apparatus, the electrical apparatus 20B is a lighting operation panel, the electrical apparatus 20C is an air-conditioner, and the electrical apparatus 20D is an elevator control panel.

The sensor 22A is an illuminance sensor, the sensor 22B is a lighting power meter, the sensor 22C is an air-conditioner sensor, the sensor 22D is an air-conditioning power meter, and the sensor 22E is an elevator power meter.

Furthermore, the sensor 22F is a power demand meter. A power demand meter is in short a meter that meters whole-building consumption of power (power consumption per building) which is supplied from an electric power supplier to the building which is a management target of the power management device 10. The power demand meter 22F is installed by, for example, the electric power supplier. Power consumption per building detected by the power demand meter 22F is sent to the electric power supplier. The power consumption per building to be sent to the electric power supplier can also be monitored by the power management device 10. As the power management device 10 is also capable of monitoring, information of the power demand can be shared between the electric power supplier and a building control personnel.

Due to the limited space of the sheet of drawing, FIG. 1 illustrates only apparatuses such as the sub-controllers 14 connected to the lower order of the power management device 10. In addition to the illustrated configurations, various other apparatuses may be connected to the power management device 10.

The power management device 10 is composed of, for example, a so-called BACnet Operator Workstation (B-OWS). The power management device 10 has a function of a client PC which is operated and monitored by the control personnel or the like, and a function of a server that performs data saving, application processing, and so on. With the power management device 10, for example, screen display and setting operations are performed.

Also, the power management device 10 receives time information from a timer 38. The received time information determines a demand term, a sampling timing of power consumption per building, a timing to change a control level, and so on, which will be described later. The timer 38 may be incorporated in the power management device 10.

The sub-controller 14 is mainly in charge of a control function. The sub-controller 14 is composed of, for example, a so-called BACnet building Controller (B-BC). The sub-controller 14 communicates with terminal transmission apparatuses such as the digital controller 16 and the remote station 18, and manages point data, schedule control, and so on. For example, one sub-controller 14 is provided to each function system (subsystem) such as an air-conditioning facility system, a lighting facility system, an elevator system, a sanitary facility system, and a crime prevention facility system.

The digital controller 16 may be a so-called Direct Digital Controller (DDC) and is provided with a function of an adjustment unit to implement decentralized control in BEMS. For example, the digital controller 16 controls the electrical apparatus 20C or 20D to which it is connected, by, for example, program control based on schedule setting sent from the sub-controller 14, and feedback control based on a goal value sent from the sub-controller 14 likewise. The digital controller 16 sends a measurement value of the sensors 22C to 22E, a warning from the electrical apparatus 20C or 20D, and so on to the above system and the other digital controller 16.

The remote station 18 is also called out-station or local station, and monitors and controls the sensors 22A and 22B and the electrical apparatuses 20A and 20B, to which it is connected. The remote station 18 functionally overlaps with the digital controller 16. Therefore, either the digital controller 16 or the remote station 18 is selected as necessary in accordance with the electrical apparatuses 20A to 20D and the sensors 22A to 22E, to which it is connected.

Each of the power management device 10, the sub-controller 14, the digital controller 16, and the remote station 18 is composed of a computer. For example, each of the power management device 10, the sub-controller 14, the digital controller 16, and the remote station 18 is provided with a Central Processing Unit (CPU) 26, a memory 28, a Hard Disk Drive (HDD) 30, an input unit 32, an output unit 34, and an input/output interface 36, as typically illustrated with the power management device 10.

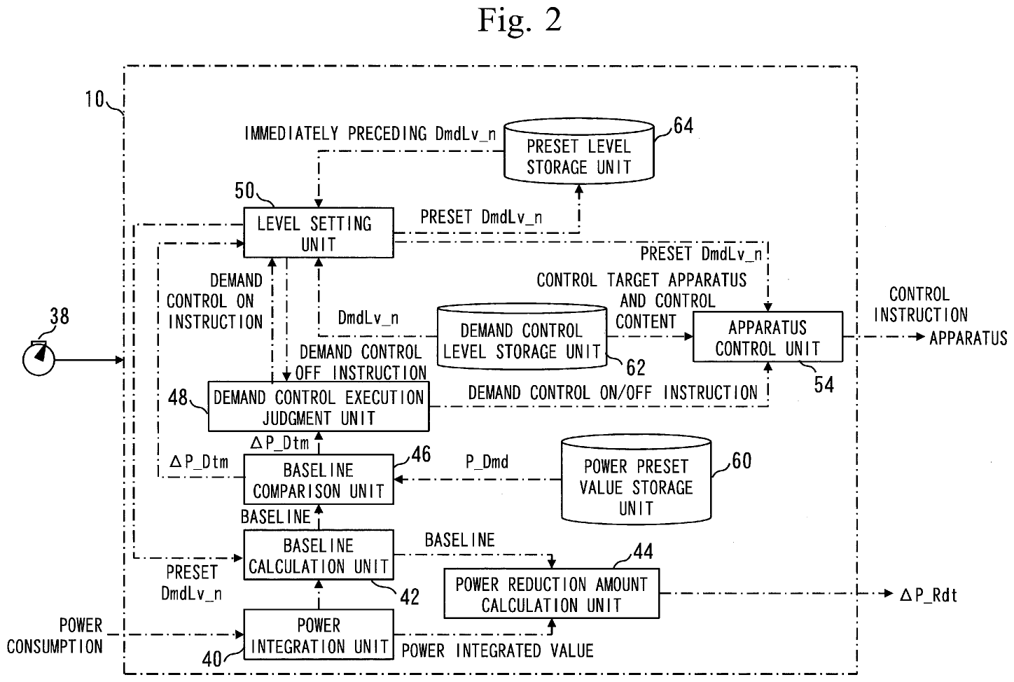

As will be described later, the CPU 26, memory 28, and HDD 30 of the power management device 10 constitute function blocks as illustrated in FIG. 2. The output unit 34 is, for example, a display, and displays, for example, a change of power consumption per building. The input unit 32 may be an input device such as a keyboard and a mouse, and can set and change a registered content of a demand control list (to be described later).

Function blocks of the power management device 10 are illustrated in FIG. 2. The power management device 10 is provided with a plurality of function units which are a power integration unit 40, a baseline calculation unit 42, a power reduction amount calculation unit 44, a baseline comparison unit 46, a demand control execution judgment unit 48, a level setting unit 50, and an apparatus control unit 54. These function blocks are constituted by assigning resources of the CPU 26, memory 28, HDD 30, and so on of the power management device 10 to them. The power management device 10 is also provided with a power preset value storage unit 60, a demand control level storage unit 62, and a preset level storage unit 64, as part of the HDD 30 and memory 28.

Operations and effects of the function blocks of the power management device 10 will be briefly described. The power integration unit 40 acquires power consumption per building from the power demand meter 22F and integrates the power consumption per building within a demand term. The baseline calculation unit 42 calculates a baseline BL which is an estimated value of the power consumption per building of a time when demand control is not performed.

The power reduction amount calculation unit 44 calculates a power reduction amount resulting from execution of demand control, based on a difference between the baseline BL and the integrated value of the actual power consumption per building at a demand-term end point. The baseline comparison unit 46 obtains a difference ΔP_Dtm between the baseline BL and a demand control execution value P_Dmd. Based on the difference ΔP_Dtm, the demand control execution judgment unit 48 judges whether or not demand control should be executed.

When executing demand control, the level setting unit 50 sets a control level. Based on the control level being set, the apparatus control unit 54 controls (suppresses) power consumption of the management target apparatus 20.

Various power preset values are stored in the power preset value storage unit 60. For example, the demand control execution value P_Dmd, a threshold P_Ctr, and so on are stored. Control contents of the individual control levels are stored in the demand control level storage unit 62. A present value of the preset control level is stored in the preset level storage unit 64. Functions and operations of these function units will be described later.

<Demand Control>

In demand control, the apparatus control unit 54 controls the power consumption of the management target apparatus 20 in the building so that the average value (power demand) of the power consumption per building in a predetermined period (for example, 30 minutes) called demand term will not exceed a predetermined contracted power.

When performing this demand control, the integrated value of power consumption per building within the demand term is used. For example, the power consumption per building is sent from the power demand meter 22F to the power integration unit 40 (see FIG. 2) of the power management device 10 at a predetermined timing (for example, one minute) within the demand term (30 minutes). Power [kW] is an instantaneous value. The power consumption per building is sent from the power demand meter 22F to the power integration unit 40 as, for example, average power of 1 minute.

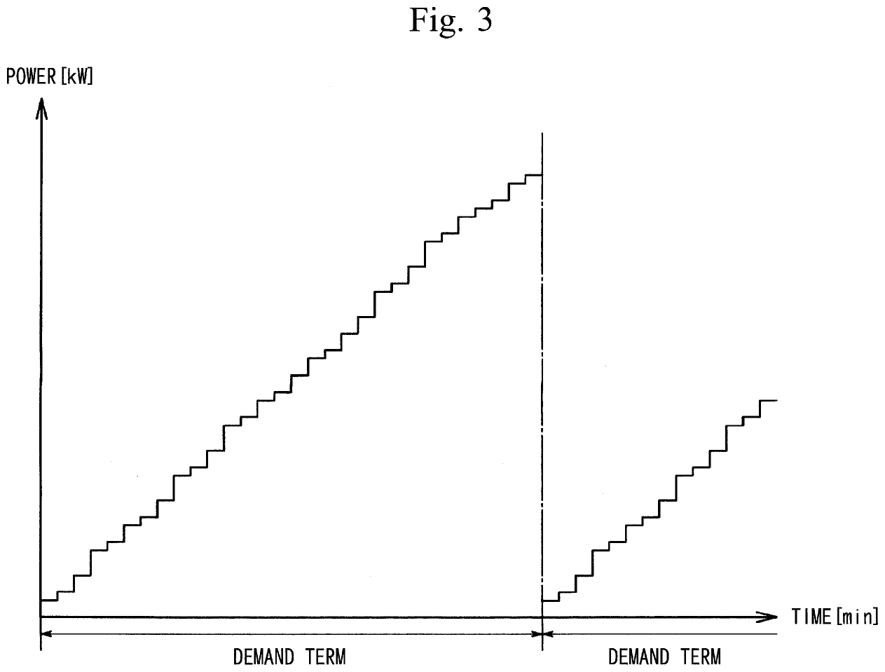

The major objective of demand control is to prevent the power demand from exceeding the contracted power. In order to enable this prevention, an integrated value of power consumption per building as illustrated in FIG. 3 is used. A graph of FIG. 3 illustrates a change of the integrated value of power consumption per building of each demand term. In the graph of FIG. 3, the axis of abscissa represents time [min], and the axis of ordinate represents power [kW].

The integrated value of power consumption per building is obtained by integrating the power consumption per building which is detected by the power demand meter 22F at predetermined sampling timings within the demand term and which is sent to the power integration unit 40. For example, if the sampling timing is every 1 minute and the demand term has duration of 30 minutes, data of power consumption per building at a maximum of 30 points is integrated by the power integration unit 40 in units of demand term. A maximum value of the integrated value of power consumption per building data is regarded as the integrated value of power consumption per building at the demand-term end point.

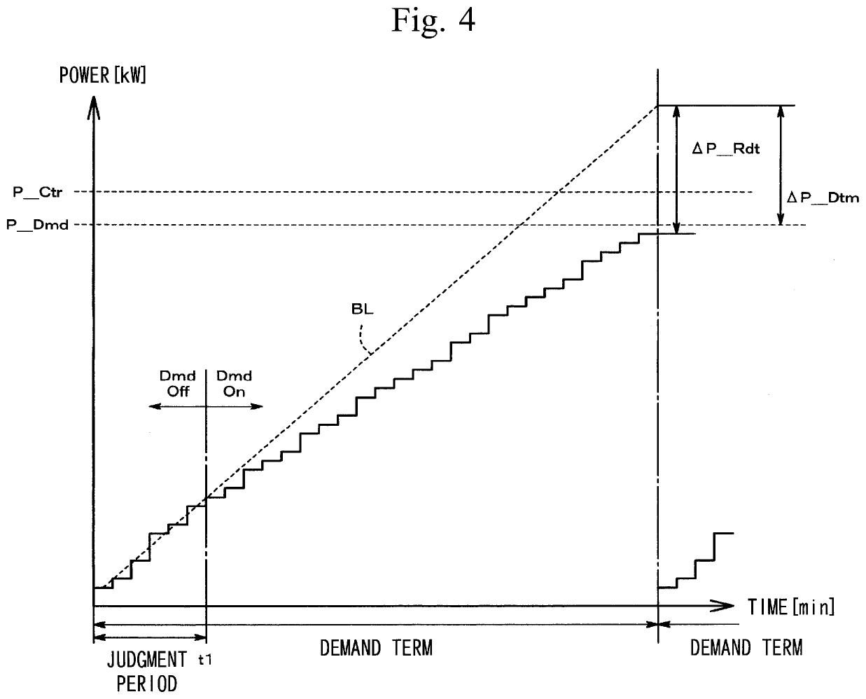

In demand control, it is judged whether or not the integrated value of power consumption per building exceeds the predetermined demand control execution value P_Dmd (see FIG. 4) between a start point and an end point of the demand term. The demand control execution value P_Dmd is set to be lower than, for example, the threshold P_Ctr which is based on the contracted power. For example, the demand control execution value P_Dmd is set at a value that is 70% or more and 90% or less of the threshold P_Ctr. The threshold P_Ctr is obtained from, for example, (contracted power)×(sampling count (for example, 30 points) in the demand term).

Demand control is a control of suppressing power consumption of the management target apparatus 20 such as an air-conditioning apparatus in a building. Since demand control is a control of suppressing power consumption of the management target apparatus 20, when the integrated value of power consumption per building is below the demand control execution value P_Dmd throughout the entire duration of the demand term, it is preferable that demand control is not executed, taking the comfort of the user of the building into consideration. Hence, a judgement period where demand control, that is, power consumption limitation on the management target apparatus, is forcibly canceled is reserved for a predetermined period in the demand term, for example, from the start point until time point t1 of the demand term, as illustrated in FIG. 4.

The baseline BL expressed by a broken line is obtained from the integrated value of power consumption per building in the judgment period. For example, based on entire data of the integrated value of power consumption per building in the judgment period, an approximate straight line is obtained by the least squares method. This approximate straight line serves as the baseline BL.

The baseline BL expresses an estimated value (predicted value) of the integrated value of power consumption per building of a case where demand control is not executed throughout the entire duration of the demand term. If this estimated value (predicted value) exceeds the demand control execution value P_Dmd by the demand-term end point, demand control is executed after end point t1 of the judgment period.

The primary objective of demand control is to prevent the power demand from exceeding the contracted power. If, however, the power demand falls excessively below the contracted power, the comfort of the user of the building may be reduced because, for example, the operation of air conditioning is excessively suppressed. Therefore, after the end point t1 of the judgment period, the integrated value of power consumption per building may be checked periodically to perform adjustment so that power consumption of the management target apparatus 20 is not suppressed excessively.

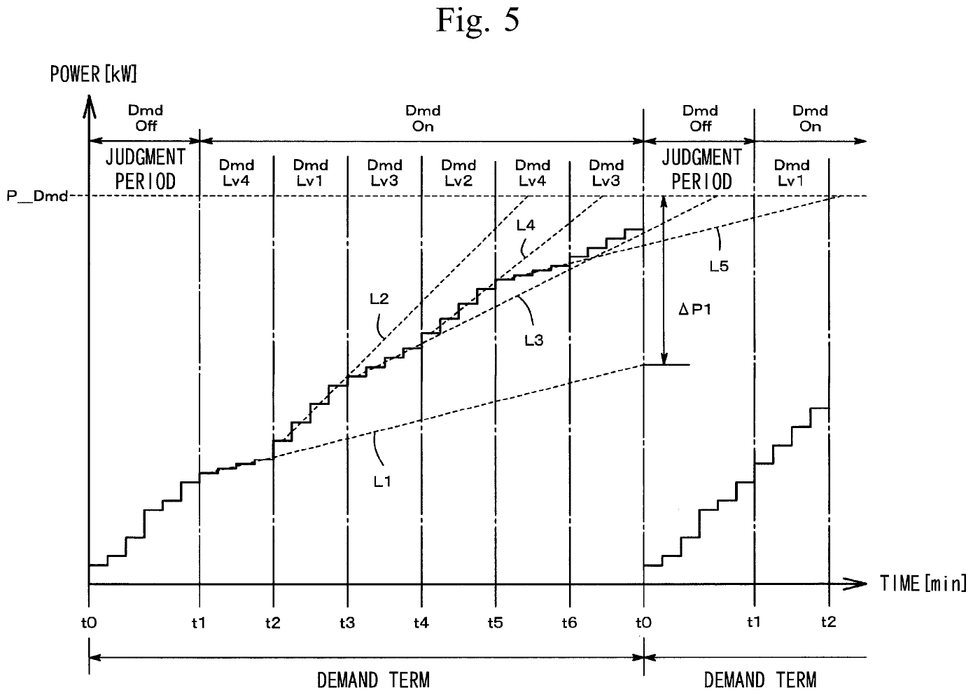

For example, as illustrated in FIG. 5, the period after time point t1 of the demand term is divided into a plurality of periods (for example, every 4 minutes), and an expected straight line Ln (L1 to L4) expressed by a broken line is obtained by plotting the integrated values of power consumption per building of the individual divisional period. A difference between a value of each expected straight line at the demand-term end point and the demand control execution value P_Dmd is calculated, and the individual differences are compared with each other to determine a control content for the next period.

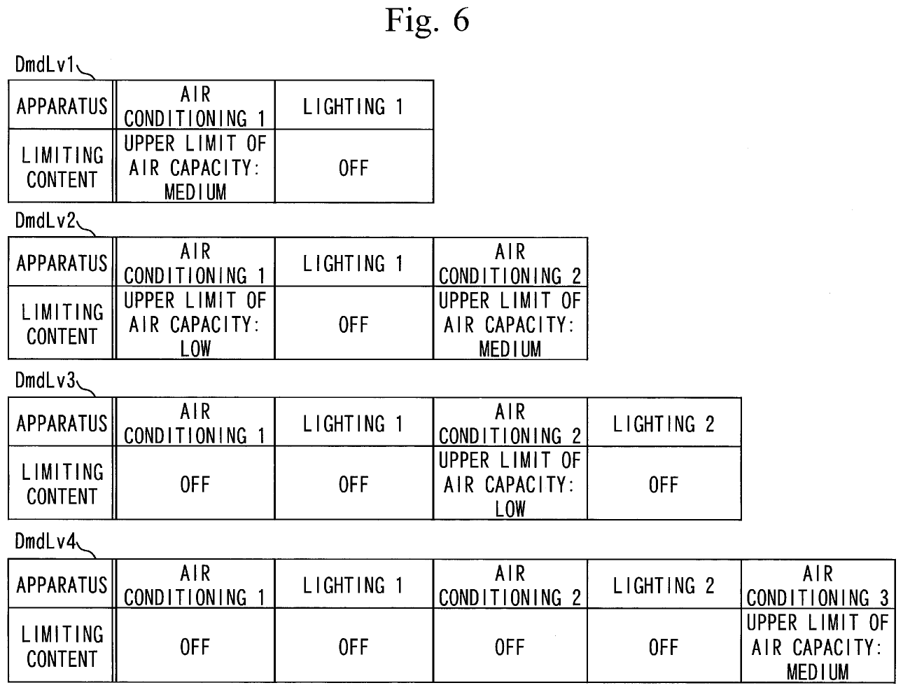

For example, reference will be made to FIGS. 2 and 6. Control items per control level are fixed in the demand control level storage unit 62. The control level prescribes the limiting degree of power consumption. In the demand control level storage unit 62, limiting contents of power consumption for the management target apparatuses are set per control level to differ among the levels. For example, the smaller the level number of the control level, the more relaxing (loose) the limiting degree.

The control items are determined for the individual apparatuses. For example, at control level DmdLv1, the upper limit of air capacity of air conditioning 1 is limited to medium (strong setting is prohibited). The higher the control level, the more the target apparatuses and the stronger their limiting contents. For example, the higher the control level is, the more the target apparatuses are added. The higher the control level, the harder the limiting content. The target apparatuses and the limiting contents can be inputted and set in advance with using the input unit 32 (see FIG. 1) of the power management device 10. As will be described later, in execution of demand control, the apparatus control unit 54 controls output of the management target apparatus 20 in accordance with the preset control level.

Getting back to FIG. 5, control level DmdLv4 is selected in a period (demand period) of time point t1 to time point t2. An expected straight line L1 is generated at time point t2, and a value of the expected straight line L1 at the demand-term terminal point is subtracted from the demand control execution value P_Dmd to obtain a difference value ΔP1. If the difference value ΔP1 exceeds a predetermined threshold, that is, if the power consumption limitation is excessive, a control level, for example, control level DmdLv1, with an easier condition than in the period of t1 to t2 is selected in the next period (t2 to t3).

When a demand term ends and a next demand term is to start, a judgment period where demand control as described above is canceled (Dmd Off) is reserved. At this time, demand control that has been executed at the preceding demand-term end point is canceled. Due to this cancellation, apparatuses that have been the power consumption limiting targets might undesirably increase their outputs simultaneously.

Referring, for example, to FIG. 5, control level DmdLv3 that has been set at the demand-term end point is canceled when the next demand term starts. For example, reference will be made to FIG. 6. When control of control level DmdLv3 is canceled, air-conditioning 1 that has been stopped starts operation, air-conditioning 2 increases its air quantity, and lightings 1 and 2 that have been OFF are turned on. In this manner, at a time of switch-over from a demand-term end point to a judgement period, apparatuses that have been the power consumption limiting targets increase their outputs simultaneously. As the apparatuses that have been the limiting targets increase their outputs simultaneously, the operating noise may become annoying to the user of the building, or the room that has suddenly become bright may make him or her feel uncomfortable.

In view of this, in the power management device 10 according to the present embodiment, a buffer period is reserved between a demand-term end point and a judgement period of the next demand term. During the buffer period, when demand control is in execution at the immediately preceding demand-term end point, the apparatus control unit 54 executes limitation relaxing control of gradually relaxing power consumption limitation for the management target apparatus 20, before the judgment period in the next demand term.

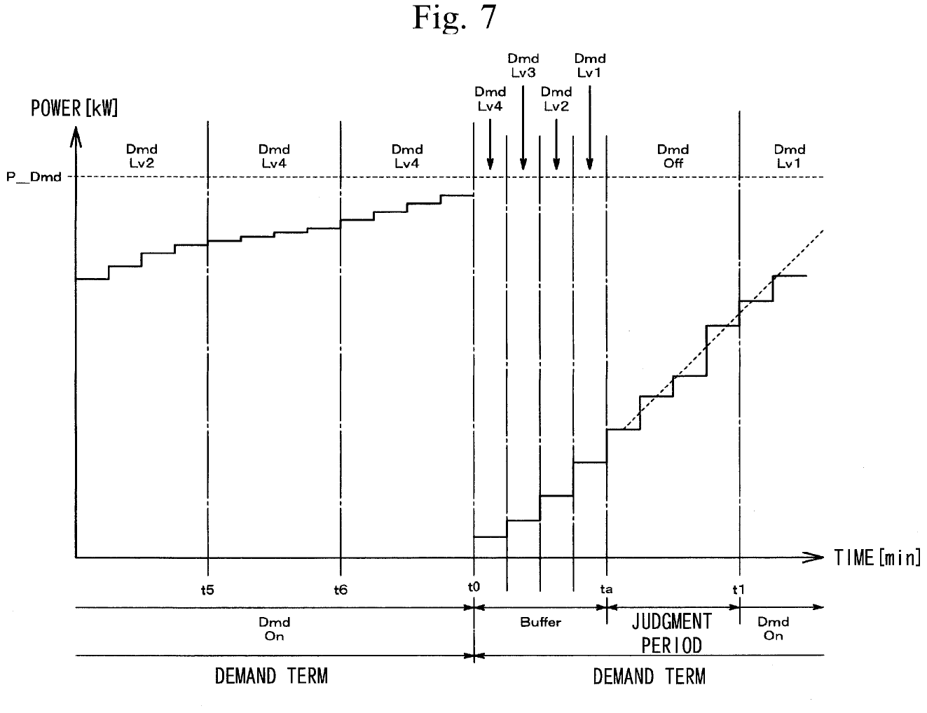

Referring, for example, to FIG. 7, when control level DmdLv4 is set at the demand-term end point, a period of start point t0 to time point to of the next demand term is set as a buffer period. During this preset buffer period, limitation relaxing control of gradually relaxing power consumption limitation for the management target apparatuses is executed. For example, in limitation relaxing control, the control level is gradually decreased. In other words, during the buffer period, the control level is shifted stepwise to a level at which the limiting content of power consumption is relaxed.

By reserving the buffer period where such limitation relaxing control is performed, power consumption limitation is gradually relaxed. This can avoid a sudden change such as simultaneous increase in outputs from the apparatuses.

<Demand Control Execution Flow>

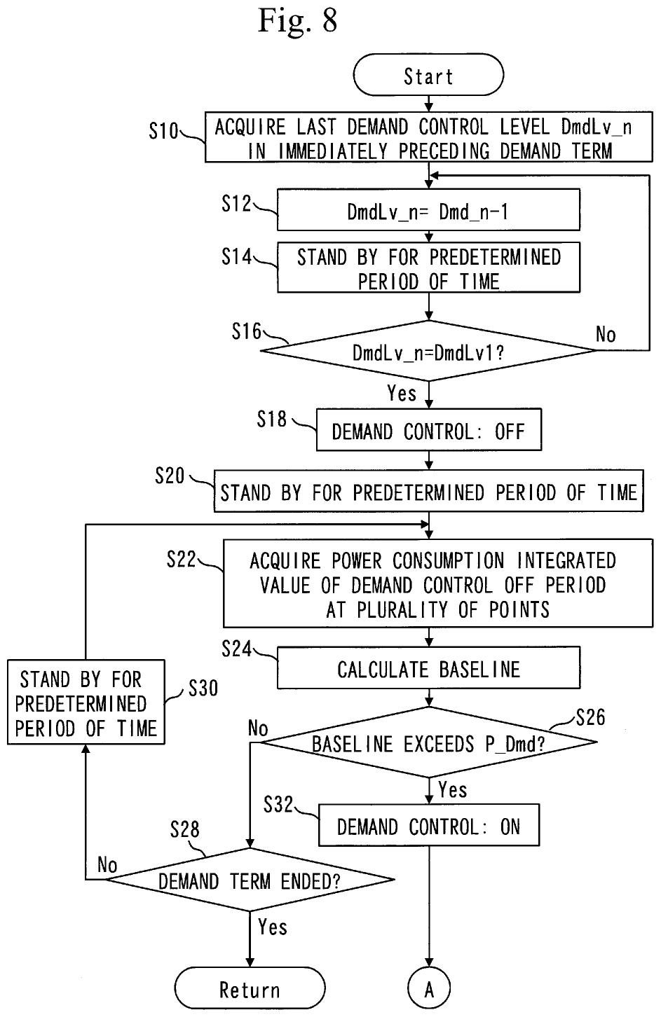

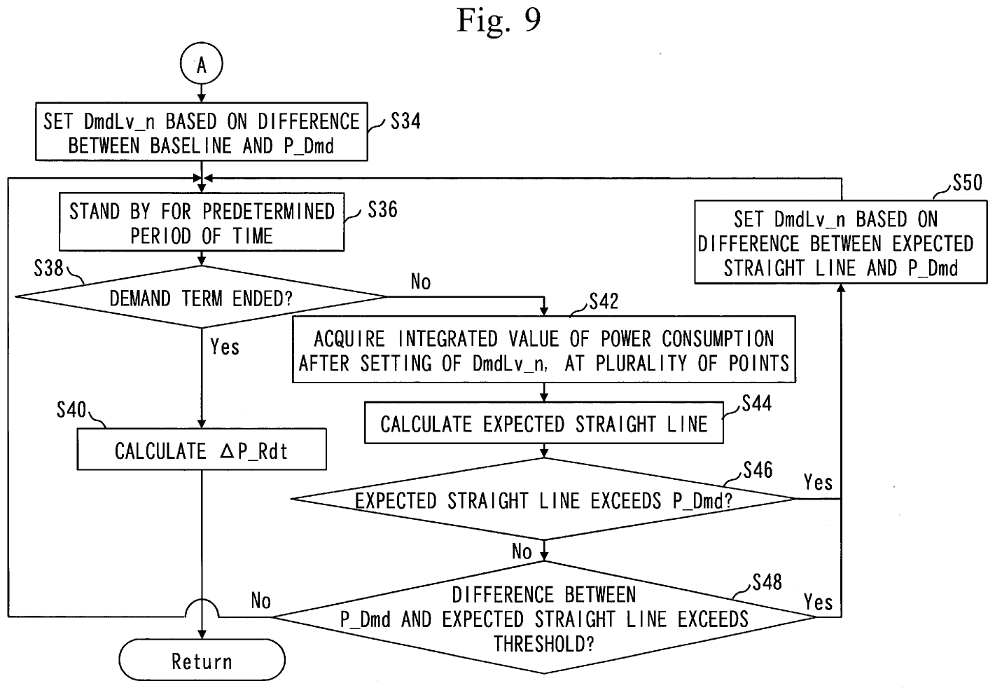

FIGS. 8 and 9 illustrate a demand control flow according to the present embodiment. This control flow is executed repeatedly for the individual demand term. Therefore, a start point (Start) of the control flow of FIG. 8 is the start point (time point t0) of a demand term.

The timer 38 (see FIG. 2) starts counting for the demand term. The power integration unit 40 resets the last integrated value to zero and integrates the value of power consumption per building which is sent from the power demand meter 22F.

Referring to FIG. 8, the level setting unit 50 acquires last (in the period after time point t6) control level DmdLv_n (n: 1 to 4) in the immediately preceding demand term (S10). For example, control level DmdLv_n during demand control execution is stored in the preset level storage unit 64. The level setting unit 50 acquires last control level DmdLv_n in the immediately preceding demand term, from the preset level storage unit 64.

Subsequently, the level setting unit 50 degrades the acquired last control level by one grade to obtain the first control level of the buffer period (S12). The degraded control level DmdLv_n is stored (updated) in the preset level storage unit 64 by the level setting unit 50. Also, the degraded control level DmdLv_n is sent to the apparatus control unit 54 by the level setting unit 50.

As limitation relaxing control, the apparatus control unit 54 refers to the demand control level storage unit 62 to acquire a control list corresponding to the degraded control level DmdLv_n from the demand control level storage unit 62. That is, the apparatus control unit 54 acquires a control target apparatus corresponding to the degraded control level DmdLv_n and a limiting content for the apparatus from the demand control level storage unit 62. The apparatus control unit 54 executes demand control (limitation relaxing control) based on the acquired control target apparatus and the acquired limiting content for the apparatus.

After the degraded control level DmdLv_n is set, the flow is in a stand-by state until a predetermined period of time elapses (S14). This predetermined period of time may be a period obtained by dividing the buffer period (time point t0 to time point ta) by the maximum value (for example, 4) of the control level.

After the lapse of the predetermined period of time, the level setting unit 50 judges whether or not the presently preset control level is the most relaxed control level DmdLv1 (S16). If the presently preset control level is not control level DmdLv1, the processing returns to step S12, and the control level is degraded stepwise.

Meanwhile, if the presently preset control level is the most relaxed control level DmdLv1, the level setting unit 50 sends to the demand control execution judgment unit 48 an OFF instruction which cancels demand control. Upon reception of the OFF instruction, the demand control execution judgment unit 48 sends the demand control OFF instruction to the apparatus control unit 54.

Upon reception of the demand control OFF instruction, the apparatus control unit 54 executes baseline judgment control of canceling the power consumption limitation for the management target apparatus 20 throughout the predetermined judgement period within the demand term (S18).

The timing at which demand control is canceled forcibly may come before the judgment period, namely, during the buffer period. For example, in a case where the last control level in the immediately preceding demand term is DmdLv1, demand control is canceled before the judgment period.

After demand control is forcibly kept canceled by the apparatus control unit 54 throughout the judgment period, the flow in FIG. 8 is in a stand-by state for a predetermined period of time (S20). This stand-by period includes a judgment period illustrated in FIG. 7.

After the judgment period elapses, the baseline calculation unit 42 acquires an integrated value of power consumption per building of the demand control OFF period (in this case, judgment period) at a plurality of points, from the power integration unit 40 (S22). Furthermore, the baseline calculation unit 42 calculates the baseline BL from the acquired integrated value of power consumption per building (S24). For example, the baseline BL may be an approximate straight line obtained from the integrated value of power consumption per building in the judgment period using the least squares method.

When calculating the baseline BL, the influence of power consumption per building of the buffer period may be excluded. For example, from each integrated value of power consumption per building of the judgment period, an integrated value in the buffer period before the judgment period, for example, an integrated value at time point ta, may be subtracted, and each obtained value may be used to calculate the baseline BL.

The calculated baseline BL is sent to the baseline comparison unit 46. The baseline comparison unit 46 extracts a demand control execution value P_Dmd from the power preset value storage unit 60. Furthermore, the baseline comparison unit 46 calculates a difference value ΔP_Dtm by subtracting a value BL (t0) of the baseline BL at the demand-term end point (t=t0) from the demand control execution value P_Dmd.

The difference value ΔP_Dtm is sent to the demand control execution judgment unit 48 by the baseline comparison unit 46. The demand control execution judgment unit 48 judges whether or not the baseline BL exceeds the demand control execution value P_Dmd by the demand-term end point (S26). In other words, the demand control execution judgment unit 48 judges whether or not the integrated value of power consumption per building which is detected by the power demand meter 22F exceeds the predetermined demand control execution value P_Dmd by the demand-term end point.

In step S26, if it is predicted by the demand control execution judgment unit 48 that the integrated value of power consumption per building does not exceed the predetermined demand control execution value by the demand-term end point, in other words, if the difference value ΔP_Dtm is 0 or more, then P_Dmd≥BL (t0), so it is predicted that the power demand will fall below the contracted power without execution of demand control. Since it is predicted that the power demand falls below the contracted power, demand control is not executed.

After that, the demand control execution judgment unit 48 judges whether or not the demand term has ended, in other words, whether or not the end point is reached (S28). If the demand term has ended, the flow returns to the start point to prepare for the next demand term.

On the other hand, if the demand term has not reached the end point in step S28, then, after a lapse of a predetermined period of time, the flow returns to step S22. Then, the integrated value of power consumption per building of the demand control OFF period including the judgment period is sent from the power integration unit 40 to the baseline calculation unit 42, and whether or not demand control is to be performed is judged again.

Getting back to step S26, if the integrated value of power consumption per building exceeds the predetermined demand control execution value by the demand-term end point, that is, if the difference value ΔP_Dtm is a negative value, then P_Dmd<BL (t0), so it is predicted by the demand control execution judgment unit 48 that the power demand will exceed the contracted power unless demand control is executed. Therefore, in a case where the difference value ΔP_Dtm is a negative value, demand control is executed by the apparatus control unit 54, after end-point time point t1 of the judgment period (S32).

When executing demand control, a demand control ON instruction is sent from the demand control execution judgment unit 48 to the level setting unit 50. The difference value ΔP_Dtm is sent from the baseline comparison unit 46 to the level setting unit 50. In response to this, the level setting unit 50 sets the control level (S34).

Qualitatively, the larger the absolute value of the difference value ΔP_Dtm, the harder control level being selected. The preset control level DmdLv_n is sent by the level setting unit 50 to the preset level storage unit 64, and is stored in the preset level storage unit 64.

The present control level DmdLv_n is sent to the apparatus control unit 54 as well. The apparatus control unit 54 extracts a control content of the control level DmdLv_n being set, specifically, a demand control target apparatus and a limiting content for it, from the demand control level storage unit 62.

Furthermore, the apparatus control unit 54 controls operations of the demand control target apparatus which is extracted from the demand control level storage unit 62, according to the limiting content for it. For example, if the target apparatus is an air-conditioning apparatus, an output upper limit of the target apparatus is determined according to the limiting content, regardless of the value being set by the controller of the air conditioning apparatus.

Furthermore, the flow in FIG. 9 is in a stand-by state for a predetermined period of time (S36). This stand-by period is a segmented demand term in FIG. 5 as described above, which is, for example, a period of time point t1 to time point t2.

After a lapse of the stand-by period, the demand control execution judgment unit 48 judges whether or not the demand term has ended (S38). When the demand term has ended, in other words, when the demand term has reached the end point, the baseline calculation unit 42 acquires an integrated value (actual measurement value) of power consumption per building at the demand-term end point, from the power integration unit 40. Furthermore, the baseline calculation unit 42 calculates a baseline BL in the demand term and obtains a value BL (t0) of the baseline BL at the demand-term end point. Furthermore, the baseline calculation unit 42 obtains a power reduction amount ΔP_Rdt (see FIG. 4) from a difference between the value BL (t0) of the baseline BL at the demand-term end point and the integrated value of power consumption per building at the demand-term end point (S40). For example, the baseline calculation unit 42 subtracts the (actual) integrated value of power consumption per building at the demand-term end point from the value BL (t0) of the baseline BL at the demand-term end point, to obtain the power reduction amount ΔP_Rdt (see FIG. 4).

The power reduction amount ΔP_Rdt expresses a power reduction amount obtained by executing demand control, and is outputted from the output unit 34 (display) of FIG. 1. Since a power reduction amount is outputted per demand term, the energy conservation effect as a result of execution of demand control becomes visible. After the power reduction amount is calculated, the flow returns to the start point in FIG. 8 to prepare for the next demand term.

Getting back to step S38, if the demand term has not ended, the baseline calculation unit 42 acquires integrated value of power consumption per building after setting of control level DmdLv_n, at a plurality of points (S42). Referring, for example, to FIG. 5, all integrated values of the power consumption per building of the period of time point t1 to t2, where the control level DmdLv4 was selected, are acquired.

Furthermore, the baseline calculation unit 42 calculates an expected straight line L1 based on the acquired integrated value of power consumption per building, in accordance with, for example, the least squares method described above (S44). Furthermore, the baseline comparison unit 46 judges whether or not the obtained expected straight line L1 exceeds the demand control execution value P_Dmd at the demand-term end point (S46).

If it is judged by the baseline comparison unit 46 that the expected straight line L1 exceeds the demand control execution value P_Dmd at the demand-term end point, the level setting unit 50 sets the control level DmdLv_n again (S50). This re-setting is executed based on a difference value ΔP1 (=L1 (t0)−P_Dmd) between the value L1 (t0) of the expected straight line L1 at the demand-term end point and the demand control execution value P_Dmd, as illustrated in FIG. 5. Then, getting back to step S36, power consumption limiting for the management target apparatus is executed based on the re-set control level DmdLv_n.

If it is judged by the baseline comparison unit 46 in step S46 that the expected straight line L1 becomes equal to or less than the demand control execution value P_Dmd at the demand-term end point, then, the level setting unit 50 judges whether or not the difference value ΔP1 (=L1 (t0)−P_Dmd) exceeds the predetermined threshold (S48).

In the previous step S46, it has turned out that the expected straight line L1 does not exceed the demand control execution value P_Dmd. Thus, in step S48, it is judged by the level setting unit 50 whether the expected straight line L1 does not excessively fall below the demand control execution value P_Dmd, namely, whether or not the power consumption is limited excessively.

When the difference value ΔP1 exceeds the predetermined threshold, the processing proceeds to step S50, and the control level DmdLv_n is set by the level setting unit 50 again. In this case, generally a less limiting control level is set. If the difference value ΔP1 is equal to or less than the predetermined threshold, the presently selected control level DmdLv_n is maintained, and the processing returns to step S36.

In this manner, in the power management device 10 according to the present embodiment, limitation relaxing control is executed between a demand-term end point and a judgment period of the next demand term, in other words, during demand control ON/OFF switching. Therefore, a sudden change in apparatus operation can be relaxed.

In the embodiment described above, the baseline BL and the expected straight line Ln are obtained from an approximate straight line based on the least squares method. However, the present invention is not limited to this. For example, as for a baseline, integrated values of power consumption per building at two points which are a start point and an end point of the judgment period may be connected, and the connecting line may be regarded as a baseline BL. As for the expected straight line Ln, integrated values of power consumption per building at two points which are a start point and an end point of time point tn to tn₊₁ may be connected, and the connecting line may be regarded as an expected straight line Ln.

Alternatively, for example, as for a baseline, integrated values of power consumption per building at two points which are a point next to the start point and a point immediately before the end point, of the judgment period may be connected, and the connecting line may be regarded as a baseline BL. As for the expected straight line Ln, integrated values of power consumption per building at two points which are a point next to the start point and a point immediately before the end point, of time point tn to tn₊₁, are connected, and the connecting line may be regarded as an expected straight line Ln.

Another way to obtain the baseline BL and the expected straight line Ln is as follows. A baseline BL may be obtained based on an integrated value of power consumption per building, excluding an integrated value of power consumption per building at time point t0 (start point). An expected straight line Ln may be obtained based on an integrated value of power consumption per building, excluding an integrated value of power consumption per building at time point tn (end point). Alternatively, a baseline BL may be obtained based on an integrated value of power consumption per building, excluding integrated values of power consumption per building at time point t0 (start point) and time point t1 (end point). An expected straight line Ln may be obtained based on an integrated value of power consumption per building, excluding integrated values of power consumption per building at time point tn (start point) and time point tn₊₁ (end point).

Still another way to obtain the baseline BL is as follows. For example, if the judgment period is a period that is 1/k time the demand term, the integrated value of power consumption per building of the baseline BL at the end point of the judgment period, that is, at time point t1, may be multiplied by k, thereby obtaining the predicted value of the baseline BL at the demand-term end point.

In the embodiment described above, each of the baseline BL and the expected straight line Ln is treated as a straight line. In brief, it suffices as far as a predicted value at the demand-term end point is obtained. Therefore, the baseline BL and the expected straight line Ln may be curves instead of straight lines.

A hardware configuration of the power management device 10 will be supplemented.

The functions of the power management device 10 described above are implemented by a program. However, functions of the power management device may be implemented by hardware.

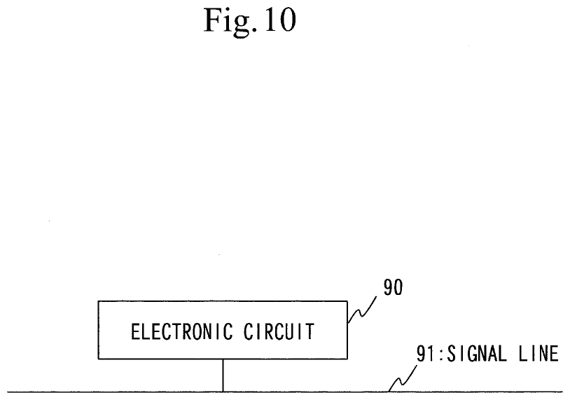

FIG. 10 illustrates a configuration in which the functions of the power management device are implemented by hardware. An electronic circuit 90 of FIG. 10 is a dedicated electronic circuit that implements functions of the power integration unit 40, baseline calculation unit 42, power reduction amount calculation unit 44, baseline comparison unit 46, demand control execution judgment unit 48, level setting unit 50, and apparatus control unit 54 of the power management device 10.

The electronic circuit 90 is connected to a signal line 91. The electronic circuit 90 is specifically a single circuit, a composite circuit, a programmed processor, a parallel-programmed processor, a logic IC, a GA, an ASIC, or an FPGA. Note that GA stands for Gate Array, ASIC for Application Specific Integrated Circuit, and FPGA for Field-Programmable Gate Array.

The functions of the constituent elements of the power management device may be implemented by one electronic circuit, or may be implemented by a plurality of electronic circuits through dispersion. Some of the functions of the constituent elements of the functions of the power management device may be implemented by an electronic circuit, and the remaining functions may be implemented by software.

The CPU and the electronic circuit 90 are both called processing circuitry as well. The functions of the power integration unit 40, baseline calculation unit 42, power reduction amount calculation unit 44, baseline comparison unit 46, demand control execution judgment unit 48, level setting unit 50, and apparatus control unit 54 of the power management device may be implemented by processing circuitry.

An operation procedure of the power management device corresponds to a power management method. A program that implements the operations of the power management device corresponds to a power management program.

### REFERENCE SIGNS LIST

10: power management device; 14: sub-controller; 16: digital controller; 18: remote station; 20: management target apparatus; 22: sensor; 38: timer; 40: power integration unit; 42: baseline calculation unit; 44: power reduction amount calculation unit; 46: baseline comparison unit; 48: demand control execution judgment unit; 50: level setting unit; 54: apparatus control unit; 60: power preset value storage unit; 62: demand control level storage unit; 64: preset level storage unit; 90: electronic circuit; 91: signal line.

1. A power management device comprising:
processing circuitry
to control power consumption of a management target apparatus installed in a building,
to detect power consumption per building, which is power consumption of the entire building, at a predetermined timing within a demand term; and
to judge whether or not an integrated value of the detected power consumption per building exceeds a predetermined demand control execution value by a demand-term end point,
wherein the processing circuitry
executes baseline judgment control of canceling power consumption limitation for the management target apparatus throughout a predetermined judgement period within the demand term,
judges whether or not a value of a baseline, which is an estimated value based on the integrated value of power consumption per building in the judgment period, exceeds the demand control execution value by the demand-term end point,
when it is judged that the value of the baseline exceeds the demand control execution value by the demand-term end point, executes demand control of limiting power consumption of the management target apparatus, after the judgment period, and
when the demand control is being executed at the demand-term end point, executes limitation relaxing control of gradually relaxing power consumption limitation for the management target apparatus, before the judgment period in a next demand term.

2. The power management device according to claim 1,
wherein the processing circuitry
executes, after the judgment period, the demand control of a predetermined control level based on a demand control list for each of a plurality of control levels at which limiting contents of the power consumption for the management target apparatuses are different, and
executes the demand control in the limitation relaxing control, so as to shift stepwise from a level executed at an end point of the immediately preceding demand term to a level at which a limiting content of power consumption is relaxed.

3. The power management device according to claim 1,
wherein the processing circuitry calculates a power reduction amount from a difference between a value of the baseline at the demand-term end point and an integrated value of power consumption per building at the demand-term end point.

4. The power management device according to claim 2,
wherein the processing circuitry calculates a power reduction amount from a difference between a value of the baseline at the demand-term end point and an integrated value of power consumption per building at the demand-term end point.
